(19) United States
(12) Patent Application Publication
(10) Pub. No.: US 2006/0246864 A1
(43) Pub. Date: Nov. 2, 2006

(54) Post-IM3-Cancellation frequency translation

(75) Inventor: Woonyun Kim, Gyeonggi-do (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/356,257

(22) Filed: Feb. 17, 2006

(30) Foreign Application Priority Data
Apr. 29, 2005 (KR) P2005-0036334

(51) Int. Cl. H04B 1/10; H04B 1/26

(52) U.S. Cl. 455/295; 455/313

(57) ABSTRACT

A method, of reducing distortion due to a third order intermodulation (IM3) product, may include: receiving an original signal; and performing, before frequency translation is done to the original signal or a version thereof, steps that include the following, firstly manipulating the original signal to form a first manipulated signal that includes a first IM3 product, secondly manipulating the original signal to form a second manipulated signal that includes a second IM3 product, and combining (A) one of the first manipulated signal or a version thereof having substantially the same frequency with (B) one of the second manipulated signal or a version thereof having substantially the same frequency such that the second IM3 product is used to substantially counteract the first IM3 product.

### PRIORITY STATEMENT

This application claims priority under 35 U.S.C. § 119(e) upon Korean Patent Application No. 10-2005-0036334 filed on Apr. 29, 2005, the entirety of which is hereby incorporated by reference.

### BACKGROUND OF THE PRESENT INVENTION

Typical radio frequency (RF) transmission/reception occurs at frequencies that are so high that performing signal processing at such frequencies is considered impractical according to the Background Art. As a result, processing of information signals according to the Background Art is performed at lower frequencies and translated to the higher frequencies at which the communication of the frequency-translated signals occurs.

Frequency conversion can be either an up-conversion to the higher frequencies at which signals that are to be transmitted or down conversion to the lower frequencies at which signals are to be processed. Typically, such frequency conversion involves the use of a mixer. Mixing via a mixer is a non-linear operation by which an original signal and a local oscillator signal are multiplied together to produce spectral images at the sum and difference frequencies. Unfortunately, harmonic frequencies of the fundamental frequencies also become mixed and distorted due to non-linearities in the electronic components of the receiver/transmitter, which (in part) yields third order intermodulation (IM3) distortion.

One approach by which the Background Art addresses IM3 distortion is depicted in FIG. 9.

In FIG. 9, a receiver is depicted that includes a main mixer 3, a compensation mixer 4 and a phase shifter 9. Mixers 3 & 4 include current switches SW1 & SW2 and transconductance amplifiers A1 & A2, respectively. The outputs of current switches SW1 & SW2 exhibit respective IM3 distortions IM3_{M} and IM3_{C}. Components of mixers 3 & 4 are selected so that IM3_{M}=IM3_{C}, and so that the signal produced by mixer 4 is out of phase with the signal produced by mixer 3. The outputs of mixers 3 and 4 are added at adder 5, with the result that the IM3 distortion is cancelled. However, according to the Background Art in FIG. 9, there exists problems that current in a local oscillator increases and additional inductor is needed in the local oscillator for phase shifting.

Signal manipulation in FIG. 9 that occurs before the IM3 cancellation at adder 5 can be described as Pre-IM3-Cancellation signal manipulation. This is indicated by a phantom line 7 in FIG. 9. Signal manipulation in FIG. 9 that can occur after the IM3 cancellation at adder 5 can be described as Post-IM3-Cancellation signal manipulation. This is indicated by a phantom line 8 in FIG. 9. Frequency translation in FIG. 9 is performed on a Pre-IM3-Cancellation basis.

### SUMMARY OF THE PRESENT INVENTION

An embodiment of the present invention provides a method of reducing distortion due to a third order intermodulation (IM3) product. Such a method may include: receiving an original signal; and performing, before frequency translation is done to the original signal or a version thereof, steps that include the following, firstly manipulating the original signal to form a first manipulated signal that includes a first IM3 product, secondly manipulating the original signal to form a second manipulated signal that includes a second IM3 product, and combining (A) one of the first manipulated signal or a version thereof having substantially the same frequency with (B) one of the second manipulated signal or a version thereof having substantially the same frequency such that the second IM3 product is used to substantially counteract the first IM3 product.

An embodiment of the present invention provides a method of frequency-translating a given signal. Such a method may include: reducing distortion in a version of the given signal, that arises from a third order intermodulation (IM3) product, by performing the distortion reduction method described above upon the given signal before frequency translation thereof; and frequency translating the combined signal obtained by the step of performing the distortion reduction method.

An embodiment of the present invention provides an apparatus for reducing distortion due to a third order intermodulation (IM3) product, the apparatus comprising: a first manipulator circuit to manipulate an original signal before frequency translation thereof and so obtain a first manipulated signal that includes a first IM3 product; a second manipulator circuit to manipulate the original signal before frequency translation thereof and so obtain a second manipulated signal that includes a second IM3 product; and a coupler to combine (A) one of the first manipulated signal or a version thereof having substantially the same frequency with (B) one of the second manipulated signal or a version thereof having substantially the same frequency before frequency translation thereof, respectively, such that the second IM3 product substantially counteracts the first IM3 product in a resulting combination signal.

An embodiment of the present invention provides a frequency translator for frequency-translating a given signal. Such a frequency translator, comprising: a distortion reduction apparatus as described above for reducing distortion in the given signal before frequency translation thereof, the distortion arising from a third order intermodulation (IM3) product; and a mixer to frequency-translate the combined signal output by the coupler of the distortion reduction apparatus.

Additional features and advantages of the invention will be more fully apparent from the following detailed description of example embodiments, the accompanying drawings and the associated claims.

### BRIEF DESCRIPTION OF THE DRAWINGS

FIG. 9 illustrates a receiver that uses frequency translation on a Pre-IM3-Cancellation basis, according to the Background Art.

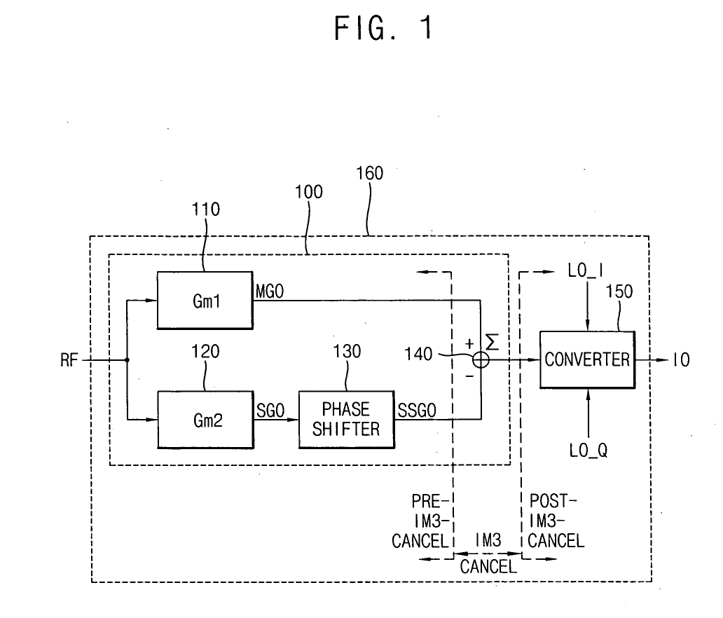

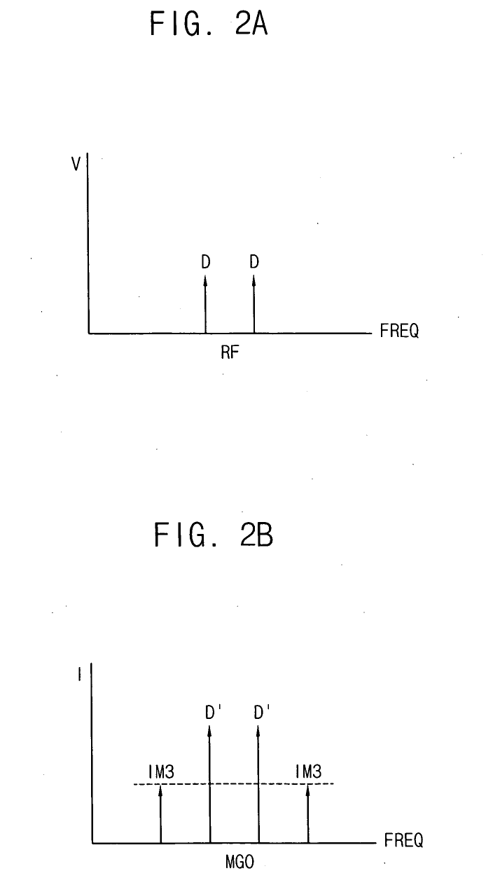

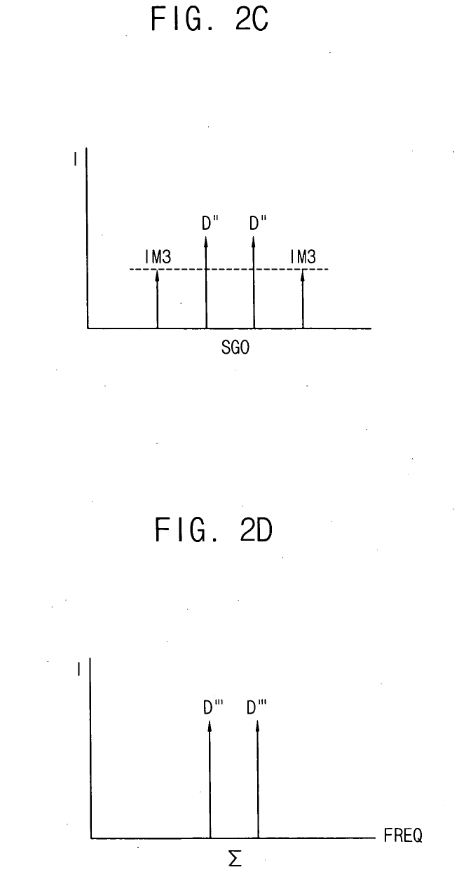

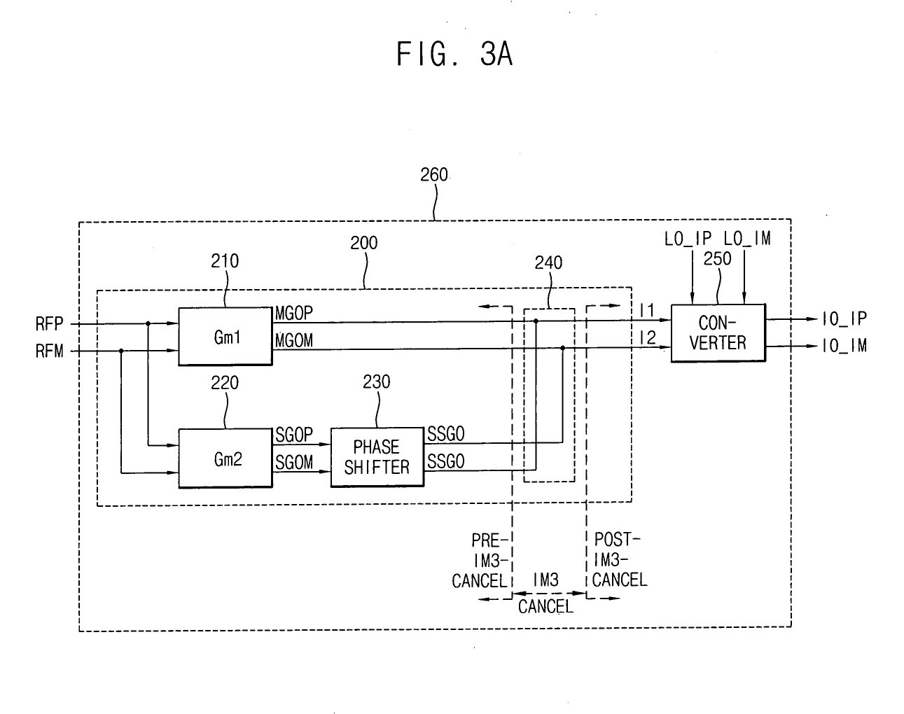

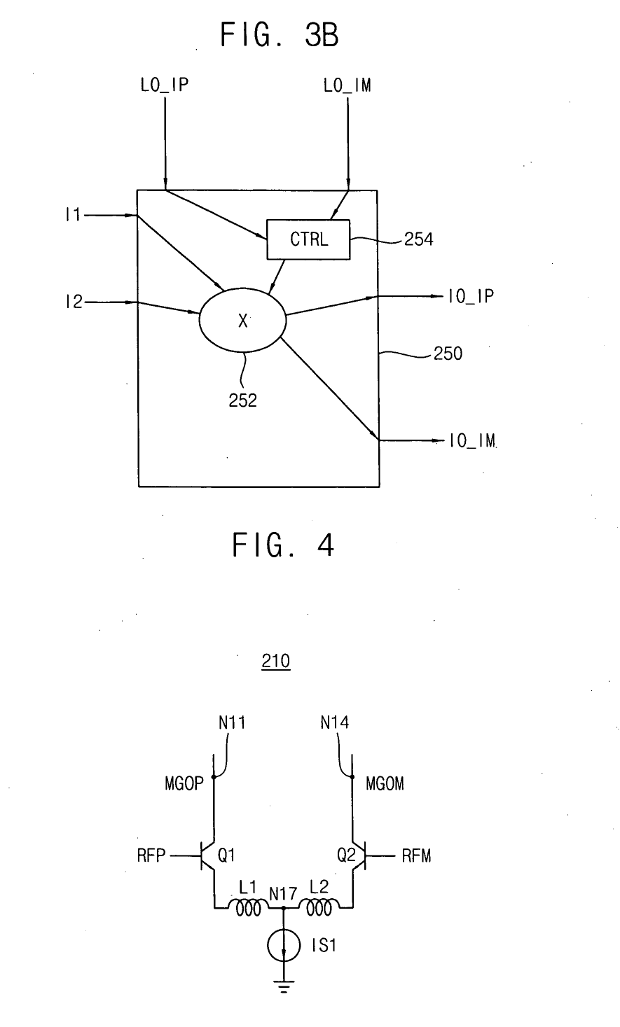

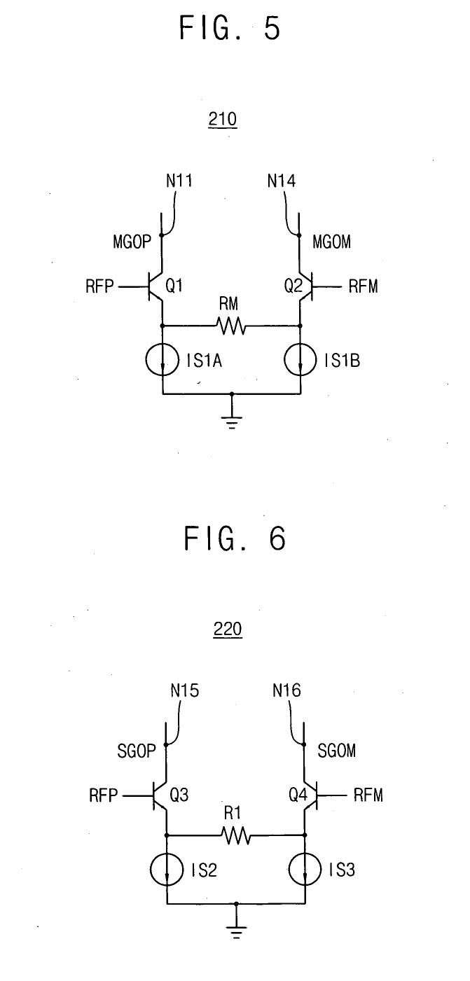

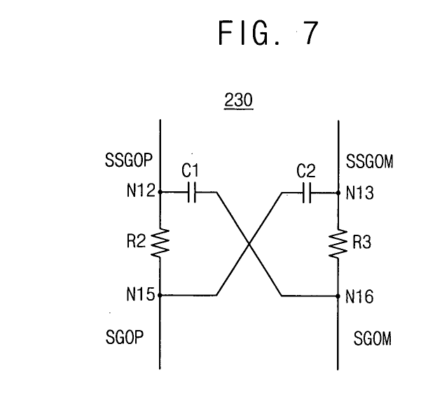

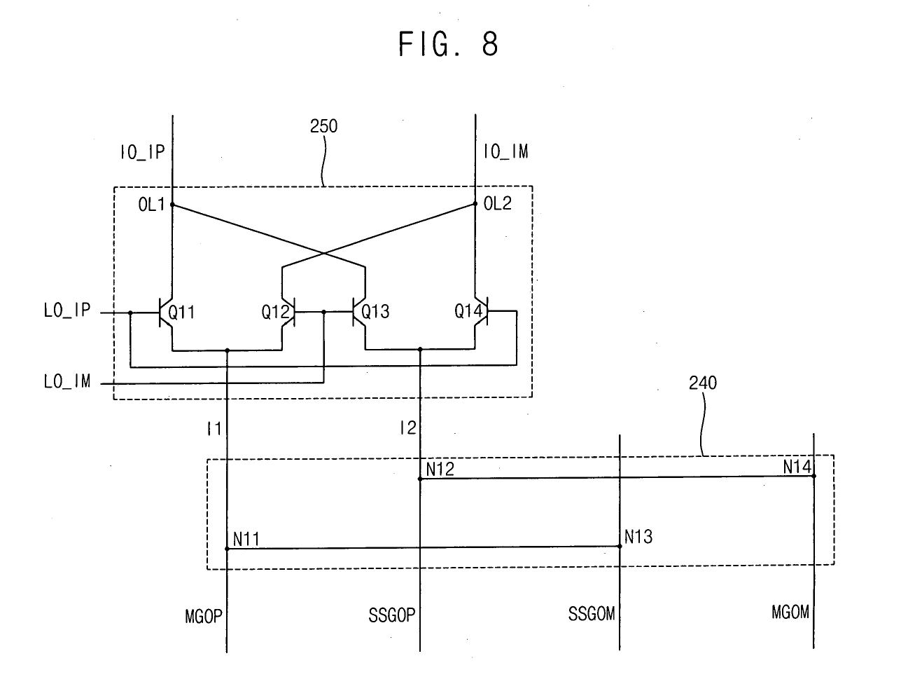

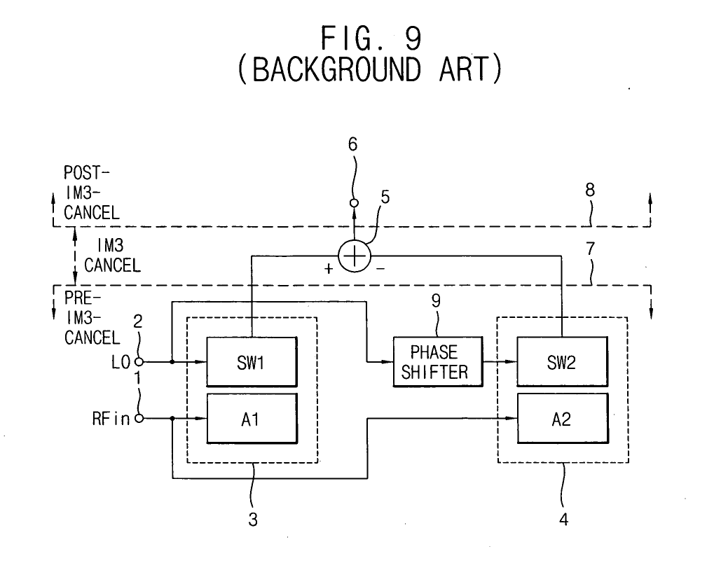

The remaining drawings are: intended to depict example embodiments of the invention and should not be interpreted to limit the scope thereof. The drawings are not drawn to scale.

FIG. 1 illustrates an apparatus for reducing distortion due to an IM3 product, according to an embodiment of the present invention. That distortion reduction apparatus is included within a frequency translator, according to an embodiment of the present invention.

FIGS. 2A-2D depict components of signals produced in the receiver of FIG. 1.

FIG. 3A illustrates an apparatus for reducing distortion due to an IM3 product, according to an embodiment of the present invention. That distortion reduction apparatus is included within a frequency translator, according to an embodiment of the present invention.

FIG. 3B illustrates an example construction of the converter of FIG. 3b, according to an embodiment of the present invention.

FIG. 4 illustrates an example construction of the main transconductance amplifier (TA) of FIG. 3B, according to an embodiment of the present invention.

FIG. 5 illustrates another example construction of the main TA of FIG. 3B, according to an embodiment of the present invention.

FIG. 6 illustrates an example construction of the ancillary TA of FIG. 3B, according to an embodiment of the present invention.

FIG. 7 illustrates an example construction of the phase shifter of FIG. 3B, according to an embodiment of the present invention.

FIG. 8 illustrates example constructions of coupler 240 and converter 250 of FIG. 3B, according to an embodiment of the present invention.

### DETAILED DESCRIPTION OF EXAMPLE EMBODIMENTS

FIG. 1 illustrates an apparatus 100 for reducing distortion due to a third order intermodulation (again, IM3) product, according to an embodiment of the present invention. Distortion reduction apparatus 100 is included within a frequency translator 160, according to an embodiment of the present invention.

In FIG. 1, frequency translator 160 can be included, e.g., as part of a wireless telephony device. Frequency translator 160 can be described as frequency-translating on a Post-IM3-Cancellation basis.

In FIG. 1, distortion reduction apparatus 100 includes: a main transconductance amplifier (TA) 110 having a gain Gm1; an ancillary TA 120 having a gain Gm2; a phase-shifter 130; and a coupler 140. The frequency translator 160 includes the distortion reduction apparatus 100 and a converter 150. Another name for a TA is a voltage controlled current source (VCIS). TAs 110 & 120 each receive a radio frequency signal RF, e.g., a wireless telephony signal. TAs 110 & 120 output amplified signals MGO and SGO, respectively.

Phase-shifter 130 shifts the phase of signal SGO by, e.g., substantially 180° and outputs a shifted version SSGO. Alternatively, phase-shifter 130 could be located between TA 110 and coupler 140 rather than between TA 120 and coupler 140.

Coupler 140 combines signals MGO and SSGO and outputs a combined signal Σ. Because signal SSGO is shifted in phase relative to signal MGO, the input of coupler 140 that receives signal SSGO is labeled with a minus (“−”) sign rather than a plus (“+”) sign.

Converter 150 receives signal Σ and frequency-translates, e.g., downconverts, it to a signal IO that has a lower frequency relative to the frequency of the original signal RF. The frequency to which signal IO is set by converter 150 is under the control of one or more local oscillator (LO) signals, e.g., orthogonal I & Q signals LO_I and LO_Q, respectively. Alternatively, converter 150 can be made to operate as an upconverter, or selectively as a downconverter or an upconverter.

Signals MGO and SGO each comprise at least one desired component (D′ or D″) and one or more distortion components that include a third order intermodulation (IM3) product. The desired component (D′) of signal MGO can have a magnitude greater than the desired component (D″) of signal SGO, which reflects the gain of TA 110 being greater than the gain of TA 120. The IM3 product (IM3_{SGO}) in signal SGO should have substantially the same (if not the same) magnitude as the IM3 product (IM3_{MGO}) in signal MGO.

The above-noted relations can be written in the form of equations, as follows:
Gm1>Gm2 (1)
D′>D″ (2)
IM3_{MGO}≈IM3_{SGO} (3)

As a practical matter, the gain of TA 110 should be significantly (or, in other words, non-negligibly) different than the gain TA 120, namely
Gm1≠Gm2 (4)

In view of Equation No. (3), TA 120 can be described as an IM3 replicator. TA 120 is configured to satisfy Equation No. (3), and to achieve a non-zero value for D′−D″. The latter is satisfied by configuring TA 120 so that
D′≠D″ (5)

The amount or ratio by which TA 120 increases the magnitude of the desirable component D″ in signal SGO is ancillary relative to satisfying Equation No. (3). Accordingly, TA 120 can be implemented with a relatively poorer quality construction than TA 110 and yet satisfactory results can be obtained.

In FIG. 1, as noted, D′ is greater than D″ (see, Equation No. (2)) because Gm1 is greater than Gm2 (see Equation No. (1)). Alternatively, Gm2 could be greater than Gm1 such that D″ would be greater than D′.

FIGS. 2A-2D depict components of signals produced in receiver 100 of FIG. 1. Thus, FIGS. 2A-2D enhance the discussion of FIG. 1.

FIG. 2A, more particularly, depicts a hypothetical example of the original signal RF provided to each of TAs 110 & 120. In FIG. 2A, the X-axis represents frequency and the Y-axis represents voltage. This example of the original signal RF can be described as a two-tone waveform whose desired components have a magnitude D.

FIG. 2B, more particularly, continues the example begun with FIG. 2A by depicting a hypothetical example of signal MGO output by TA 110. In FIG. 2B, the X-axis represents frequency and the Y-axis represents current. Non-linearities in TA 110 have introduced distortions into signal MGO which include IM3 products. It is to be observed that the desired components have been amplified and now have a magnitude D′.

FIG. 2C, more particularly, continues the example begun with FIG. 2A by depicting a hypothetical example of signal SGO output by TA 120. In FIG. 2C, the X-axis represents frequency and the Y-axis represents current. Non-linearities in TA 120 have introduced distortions into signal SGO which include IM3 products. It is to be observed that the desired components have been amplified and now have a magnitude D″.

FIG. 2D, more particularly, continues the example begun with FIG. 2A by depicting a hypothetical example of signal Σ output by coupler 140. In FIG. 2D, the X-axis represents frequency and the Y-axis represents current. It is to be observed that the desired components have a magnitude D′−D″ and that the IM3 product of signal SGO has counteracted (substantially, if not totally, canceled) the IM3 product of signal MGO (see Equation No.(3)) such that
IM3_{MGO}−IM3_{SGO}≈0. (6)

FIG. 3A illustrates an apparatus 200 for reducing distortion due to an IM3 product, according to an embodiment of the present invention. Distortion reduction apparatus 200 is included within a frequency translator 260, according to an embodiment of the present invention.

In FIG. 3A, frequency translator 260 can be included, e.g., as part of a wireless telephony device. Frequency translator 260 can be described as frequency-translating on a Post-IM3-Cancellation basis.

In FIG. 3A, distortion reduction apparatus 200 includes: a main transconductance amplifier (again, TA) 210 having a gain Gm1; an ancillary TA 220 having a gain Gm2; a phase-shifter unit 230; and a coupler 240. The frequency translator 260 includes the distortion reduction apparatus 200 and a converter 250. TAs 210 & 220 each receive a pair of radio frequency signals RFP & RFM, e.g., a wireless telephony signal. TAs 210 & 220 output pairs of amplified signals MGOP & MGOM and SGOP & SGOM, respectively.

Phase-shifter 230 shifts the phase of signals SGOP & SGOM by, e.g., substantially 180° and outputs shifted versions SSGOP & SSGOM, respectively. Alternatively, phase-shifter 230 could be located between TA 210 and coupler 240 rather than between TA 220 and coupler 240.

Coupler 240 combines the signal pair MGOP & MGOM and the signal pair SSGOP & SSGOM and outputs the pair of combined signals I1 & I2, respectively. Converter 250 receives the signal pair I1 and I2 and frequency-translates, e.g., downconverts, it to a pair of signals IO_IP & IO_IM, respectively, that has lower frequencies relative to the frequencies of the original signal pair RFP & RFM. The frequencies to which signals IO_IP & IO_IM are set by converter 250 is under the control of one or more orthogonal local oscillator (LO) signals, e.g., signals LO_IP and LO_IM, respectively. Alternatively, converter 250 can be made to operate as an upconverter, or selectively as a downconverter or an upconverter.

Signals MGOP, MGOM, SGOP and SGOM each comprise at least one desired component ( D′ or D″) and one or more distortion components that include a third order intermodulation (IM3) product. The desired component (D′) of signals MGOP & MGOM can have a magnitude greater than the desired component (D″) of signals SGOP & SGOM, which reflects the gain of TA 210 being greater than the gain of TA 220. The IM3 product (IM3_{SGO}) in signals SGOP & SGOM should have substantially the same (if not the same) magnitude as the IM3 product (IM3_{MGO}) in signals MGOP & MGOM, respectively.

The operation of distortion reduction apparatus 200 and frequency translator 260 of FIG. 3A is similar to the operation of distortion reduction apparatus 100 and frequency translator 160 of FIG. 1, respectively. For the sake of brevity, no further discussion of such operation is provided.

FIG. 3B illustrates an example construction of converter 250, according to an embodiment of the present invention.

In FIG. 3B, converter 250 includes a mixer 252 and a controller 254. Mixer 252 receives the pair of combined signals I1 & I2 from coupler 240. Controller 252 receives the pair of local oscillator signals LO_IP & LO_IM and outputs a control signal to mixer 252. According to the control signal from controller 254, mixer 252 produces the signal pair IO_IP & IO_IM.

FIG. 4 illustrates an example construction of TA 210 of FIG. 3A, according to an embodiment of the present invention.

In FIG. 4, TA 210 includes a pair of bipolar junction transistors (BJTs) Q1 & Q2, e.g., NPN type. BJT Q1 receives the original signal RFP on its base and outputs signal MGOP on its collector (node N11). BJT Q2 receives the original signal RFM on its base and outputs signal MGOM on its collector (Node N14). The emitters of BJTs Q1 & Q2 are connected to a node N17 via inductors L1 & L2, respectively. Node N17 is connected to ground via a current source IS1. TA 210 in FIG. 4 is configured to be substantially linear and exhibit a large gain relative to TA 220. The gain Gm1 of TA 210 is determined primarily by the values of inductors L1 & L2.

FIG. 5 illustrates another example construction of TA 210 of FIG. 3A, according to an embodiment of the present invention.

In FIG. 5, TA 210 includes a pair of bipolar junction transistors (BJTs) Q1 & Q2, e.g., NPN type. BJT Q1 receives the original signal RFP on its base and outputs signal MGOP on its collector (node N11). BJT Q2 receives the original signal RFM on its base and outputs signal MGOM on its collector (node N14). A resistor RM is connected between the emitters of BJTs Q1 & Q2. The emitters of BJTs Q1 & Q2 also are connected to ground via current sources IS1A & IS1B. TA 210 in FIG. 5 is configured to be substantially linear and exhibit a large gain relative to TA 220. The gain Gm1 of TA 210 is determined primarily by the value of resistor RM.

FIG. 6 illustrates an example construction of TA 220 of FIG. 3A, according to an embodiment of the present invention.

In FIG. 6, TA 220 includes a pair of bipolar junction transistors (BJTs) Q3 & Q4, e.g., NPN type. BJT Q3 receives the original signal RFP on its base and outputs signal SGOP on its collector (node N15). BJT Q4 receives the original signal RFM on its base and outputs signal SGOM on its collector (node N16). A resistor R1 is connected between the emitters of BJTs Q3 & Q4. The emitters of BJTs Q3 & Q4 also are connected to ground via current sources IS2 & IS3. TA 220 in FIG. 6 is configured to be substantially non-linear because the differences between the desirable components D″ in the pair of signals SGOP & SGOM and the magnitudes of the IM3 products (IM3_{SGOP} & IM3_{SGOM}) can be small. The gain Gm1 of TA 220 is determined primarily by the value of resistor R1.

FIG. 7 illustrates an example construction of phase shifter 230 of FIG. 3A, according to an embodiment of the present invention.

In FIG. 7, phase shifter 230 receives the signal pair SGOP & SGOM on nodes N15 & N16, respectively. The phase-shifted signal pair SSGOP & SSGOM are output on nodes N12 & N13, respectively. A resistor R2 is connected between nodes N15 & N12. A resistor R3 is connected between nodes N16 & N13. A capacitor C1 is connected between nodes N12 and N16. A capacitor C2 is connected between nodes N13 and N15. The amounts of phase-shift are determined by the values of resistors R2 & R3 and capacitors C1 & C2.

FIG. 8 illustrates example constructions of coupler 240 and converter 250 of FIG. 3A, according to an embodiment of the present invention.

In FIG. 8, within coupler 240, nodes N11 and N13 are connected together, and nodes N12 and N14 are connected together.

Also in FIG. 8, converter 250 includes two pairs of BJTs Q11 & Q12 and Q13 & Q14, e.g., NPN type. Emitters of BJTs Q11 & Q12 are connected to node N11 to receive the combined signal I1. Emitters of BJTs Q13 & Q14 are connected to node N12 to receive the combined signal I2. The bases of BJTs Q11 and Q14 are connected together and receive the local oscillator signal LO_IP. The bases of BJTs Q12 and Q13 are connected together and receive the local oscillator signal LO_IM. The collectors of BJTs Q11 & Q13 are connected together at a node OL1 on which is available signal IO_IP. The collectors of BJTs Q12 & Q14 are connected together at a node OL2 on which is available signal IO_IM.

In FIGS. 4-8, NPN type BJTs have been depicted. Alternatively, PNP type BJTs could be used, or some combination of both. Also in the alternative, other types of transistors, e.g., MOSFETs, could be used instead of BJTs.

According to the present invention, using ancillary transconductance amplifier (TA) having a resistor with no inductor and performing frequency translation based on Post-IM3-Cancellation basis, the linearity and noise figure characteristics of a frequency translator is improved without current increase. Also, bulky inductor in local oscillator can be eliminated.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention as defined by the associated claims.

What is claimed:

1. A method of reducing distortion due to a third order intermodulation (IM3) product, the method comprising:
receiving an original signal; and
performing, before frequency translation is done to the original signal or a version thereof, steps that include the following,
firstly manipulating the original signal to form a first manipulated signal that includes a first IM3 product,
secondly manipulating the original signal to form a second manipulated signal that includes a second IM3 product, and
combining (A) one of the first manipulated signal or a version thereof having substantially the same frequency with (B) one of the second manipulated signal or a version thereof having substantially the same frequency such that the second IM3 product is used to substantially counteract the first IM3 product.

2. The method of claim 1, wherein the steps of first and secondly manipulating include voltage-to-current translating the original signal.

3. The method of claim 1, the method further comprising:
phase shifting the second IM3 product to produce a version of the second manipulated signal in which the second IM3 product is substantially completely out of phase with respect to the first IM3 product in the first manipulated signal;
wherein the step of combining operates upon the version of the second manipulated signal obtained in the step of phase shifting.

4. The method of claim 1, wherein the received signal is an RF signal.

5. The method of claim 4, wherein the received RF signal is a wireless communication signal.

6. The method of claim 1, wherein:
the first manipulated signal includes a first desired portion in addition to the first IM3 product;
the second manipulated signal includes a second desired portion in addition to the first IM3 product; and
the magnitude of the second desired portion is significantly smaller than the magnitude of the first desired portion.

7. A method of frequency-translating a given signal, the method comprising:
reducing distortion in a version of the given signal, that arises from a third order intermodulation (IM3) product, by performing the method of claim 1 upon the given signal before frequency translation thereof; and
frequency translating the combined signal obtained by the step of performing the method of claim 1.

8. An apparatus for reducing distortion due to a third order intermodulation (IM3) product, the apparatus comprising:
a first manipulator circuit to manipulate an original signal before frequency translation thereof and so obtain a first manipulated signal that includes a first IM3 product;
a second manipulator circuit to manipulate the original signal before frequency translation thereof and so obtain a second manipulated signal that includes a second IM3 product; and
a coupler to combine (A) one of the first manipulated signal or a version thereof having substantially the same frequency with (B) one of the second manipulated signal or a version thereof having substantially the same frequency before frequency translation thereof, respectively, such that the second IM3 product substantially counteracts the first IM3 product in a resulting combination signal.

9. The apparatus of claim 8, wherein the first and second manipulator circuits include transconductance amplifiers that operate upon the original signal, respectively.

10. The apparatus of claim 8, further comprising:
a phase shifter operable to phase-shift the second IM3 product resulting in a version of the second manipulated signal in which the second IM3 product is substantially completely out of phase with respect to the first IM3 product in the first manipulated signal;
wherein the coupler is operable upon the version of the second manipulated signal produced by the phase shifter.

11. The apparatus of claim 8, wherein:
the first manipulator circuit includes at least one inductor the presence of which introduces the phase-shift in the first manipulated signal.

12. The apparatus of claim 8, wherein the received signal is an RF signal.

13. The apparatus of claim 12, wherein the received RF signal is a wireless communication signal.

14. The apparatus of claim 8, wherein:
the first manipulated signal includes a first desired portion in addition to the first IM3 product;
the second manipulated signal includes a second desired portion in addition to the first IM3 product; and
the second manipulator circuit is further operable to set the magnitude of the second desired portion to be significantly smaller than the magnitude of the first desired portion.

15. A frequency translator for frequency-translating a given signal, comprising:
a distortion reduction apparatus as in claim 8 for reducing distortion in the given signal before frequency translation thereof, the distortion arising from a third order intermodulation (IM3) product; and
a mixer to frequency-translate the combined signal output by the coupler of the distortion reduction apparatus of claim 8.

16. The frequency translator of claim 15, further comprising:
a control circuit to control the mixer selectively to operate as an up-converter or a down-converter.

17. An apparatus for reducing distortion due to a third order intermodulation (IM3) product, the apparatus comprising:
amplifying means for amplifying an original signal before frequency translation thereof to produce a first amplified signal that includes a first IM3 product;
IM3 replicating means for replicating the first IM3 product before frequency translation thereof and including the same in a sacrificial signal before frequency translation thereof;
offsetting means, operable upon the first amplified signal and the sacrificial signal before frequency translation thereof, respectively, for offsetting the first IM3 product using the replicated version thereof.

18. A frequency translator, for frequency-translating a given signal, comprising:
the distortion reduction apparatus of claim 17 for reducing distortion in the given signal before frequency translation thereof, the distortion arising from a third order intermodulation (IM3) product; and
mixing means for frequency-translating an output of the offsetting means of claim 17.
